(19) United States
(12) Patent Application Publication
(10) Pub. No.: US 2018/0303155 A1
(43) Pub. Date: Oct. 25, 2018

(54) SMOKERS MULTI TOOL

(71) Applicants: Robert Criss, New Brunswick, NJ (US); Ivan Castro, New Brunswick, NJ (US)

(72) Inventors: Robert Criss, New Brunswick, NJ (US); Ivan Castro, New Brunswick, NJ (US)

(21) Appl. No.: 15/860,986

(22) Filed: Jan. 3, 2018

Related U.S. Application Data
(60) Provisional application No. 62/487,917, filed on Apr. 20, 2017.

(51) Int. Cl. A24F 9/00; B25F 1/00

(52) U.S. Cl. CPC A24F 9/00; A24C 5/40; B25F 1/003

(57) ABSTRACT

A smoker's multi-tool that integrates one or more tools for various tasks associated with smoking. The smoker's multi-tool includes one or more tools mounted within a housing, the one or more tools may be rotated from a closed non-functional position within the housing to an open, functional position extending outward from the housing. A first spring mounted within the housing has first and second prongs wherein the first prong engages one of the one or more tools whereby spring tension of the first prong is exerted against the one of the one or more tools secured within the housing in the closed non-functional position. An end of the first prong engages the one of the one or more tools whereby the first prong moves into an unstressed condition when the multi-tool is secured in an open position.

### CROSS-REFERENCE TO RELATED APPLICATIONS

This application claims the benefit of U.S. Provisional Patent Application No. 62/487,917 filed on Apr. 20, 2017 which is incorporated herein by reference.

### FIELD OF INVENTION

The present invention relates to a smoking aid, and in particular, to a smoker's multi-tool that combines and stores one or more tools into a single device.

### BACKGROUND OF THE INVENTION

Hand rolled cigarettes made from loose tobacco and the use of loose leaf tobacco in pipes have existed for a long time. Over time, certain tools that aid in smoking tobacco from a hand rolled cigarette or pipe have been developed. In addition, medicinal marijuana usage has also been around for a long time in various forms. Marijuana may be smoked in hand rolled cigarettes, pipes, and additionally may be utilized in the form of pure Tetrahydrocannabinol (THC). THC is the chemical responsible for most of marijuana's psychological effects.

In its medicinal form THC is a waxy substance that s scooped out of a container in all dosages to be smoked. Because smoking pure THC is a relatively new concept, the instruments used in the process are still evolving. The tools used for smoking loose leaf tobacco or marijuana and the tools used for smoking pure THC, however, are different. There has never been a convenient way to carry such tools, and carrying around both sets of tools can be cumbersome.

### SUMMARY OF THE INVENTION

According to another embodiment of the present invention, there is disclosed a smoker's multi-tool that integrates one or ore tools for various tasks associated with smoking. The smoker's multi-tool includes one or more tools mounted within a housing, the one or more tools may be rotated from a closed non-functional position within the housing to an open, functional position extending outward from the housing. A first spring mounted within the housing has first and second prongs wherein the first prong engages one of the one or more tools whereby spring tension of the first prong is exerted against the one of the one or more tools secured within the housing in the closed non-functional position. An end of the first prong engages the one of the one or more tools whereby the first prong moves into an unstressed condition when the multi-tool is secured in an open position.

According to another embodiment of the present invention, there is disclosed a smoker's multi-tool that integrates a plurality of tools for various tasks associated with smoking. The smoker's multi-tool includes a housing having the plurality of tools mounted therein, the housing comprising a first inner cover and a second inner cover, an intermediate support segment disposed between the first inner cover and the second inner cover, a first spring between the first inner cover and the intermediate support segment and a second spring between the intermediate support segment and the second inner cover. A first of the plurality of tools is mounted between the first inner cover and the first spring, a second of the plurality of tools is mounted between the first spring and the intermediate support segment, a third of the plurality of tools is mounted between the intermediate support segment and the second spring, and a fourth of the plurality of tools is mounted between the second spring and the second inner cover whereby the plurality of tools may be rotated from a closed non-functional position within the housing to an open, functional position extending outward from the housing.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

These and other objects of the present invention will become apparent, particularly when taken in light of the following illustrations wherein:

FIG. 1 is a front three-dimensional view of the smoker's multi-tool, in accordance with the present invention.

FIG. 2 is a rear three-dimensional view of the smoker's multi-tool, in accordance with the present invention.

FIG. 3 is an exploded view of the smoker's multi-tool, in accordance with the present invention.

FIG. 4 is a three-dimensional view of the tool attachment in a closed position relative to the spring, in accordance with the present invention.

FIG. 5 is a three-dimensional view of the tool attachment in a mid-open position relative to the spring, in accordance with the present invention.

FIG. 6 is a three-dimensional view of the tool attachment in an open and functional position relative to the spring, in accordance with the present invention.

### DETAILED DESCRIPTION OF THE INVENTION

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Multi-function tools are well known. In typical multi-function tools, pliers and other selected tools, such as screwdrivers, knife blades, files, etc., are provided in a single tool. Known multi-function tools often include pliers and have channel-shaped handles pivotally connected to the tangs of the pliers. The handles fold over so that the pliers are received in the channel-shaped handles. Also, the other tools fold over and are received in the channel-shaped handles as well.

Many people enjoy smoking recreational herbal substances. There are presently several different types of smokers' accessories that are available to help store and organize the various implements and paraphernalia that are required for the preparation of herbal cigarettes. The smoker's multi-tool seeks to provide an improved smoker's accessory that integrates a variety of attachments 12 for various tasks associated with smoking.

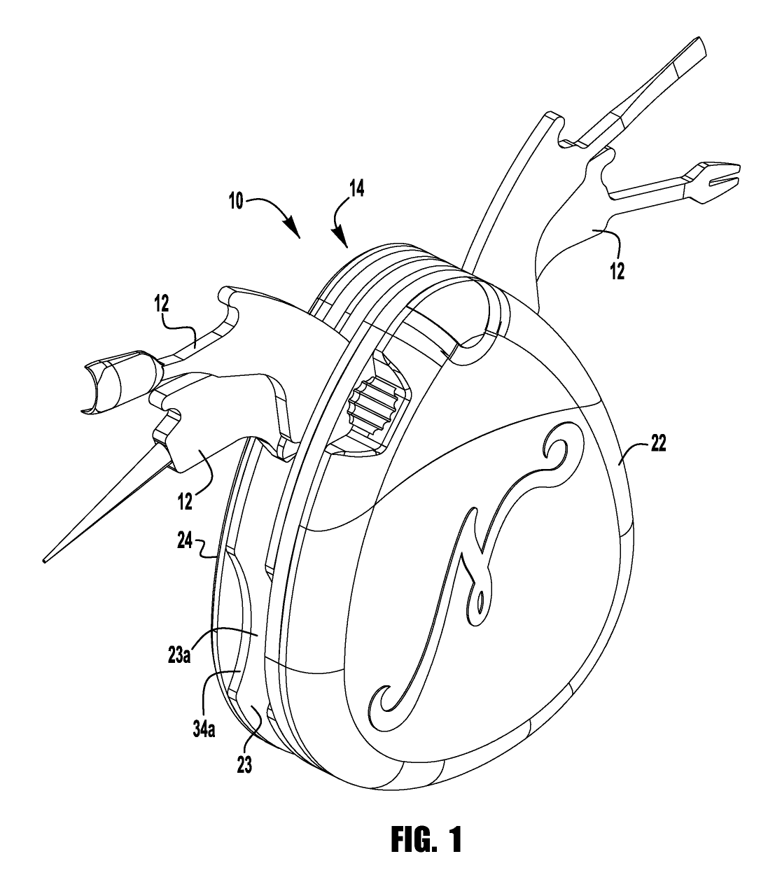

The smoker's multi-tool 10, depicted in FIG. 1 is shown in a closed, compact configuration. The smoker's multi-tool 10 incorporates one or more tools 12 within a housing 14 which accepts and holds interchangeable tools of different sizes and types. When in use, the tools 12 may be securely locked in a closed position or an extended position with respect to the housing 14, and secured by one or more springs 16 and 18, respectively, an intermediate segment 20, and first and second inner supports 23 and 25. The smoker's multi-tool 10 combines multiple tools into a single device and stores these tools in a compact fashion. The advantage of the smoker's multi-tool 10 is that it prevents the user from having to carry around multiple tools at once. A user is also less likely to lose or misplace one the tools when they are all combined into a single device.

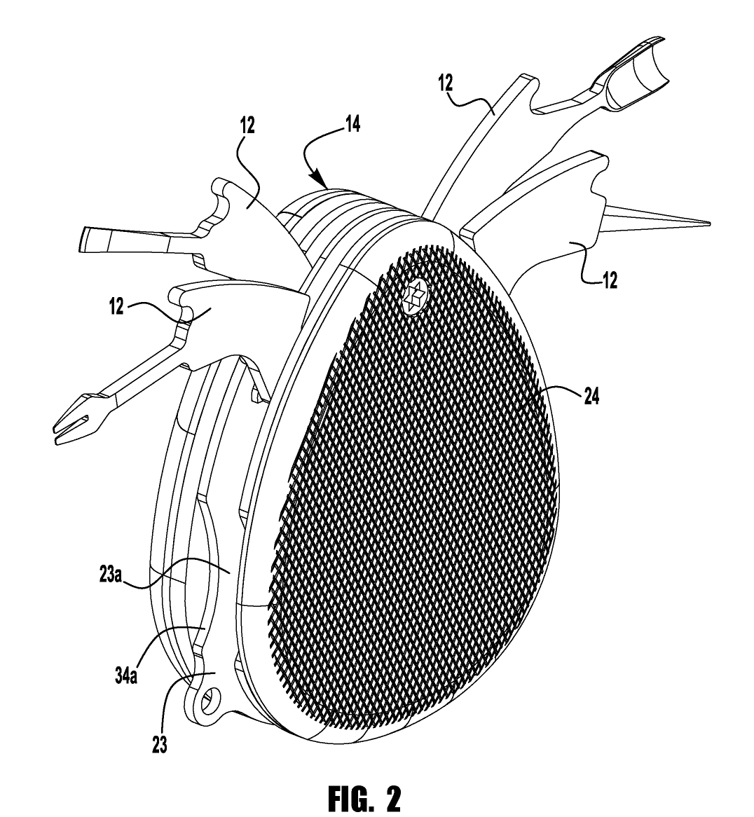

In the current embodiment as shown in FIGS. 1 and 2, the smoker's multi-tool 10 generally conforms to a shape of a plectrum. However, the smoker's multi-tool can also take the shape of a rectangle, square, circle, or any other desired shape without departing from the scope of the present invention. Typically, the attachments 12 and housing 14 are constructed of metal or plastic polymer, although any appropriate materials may be utilized for construction.

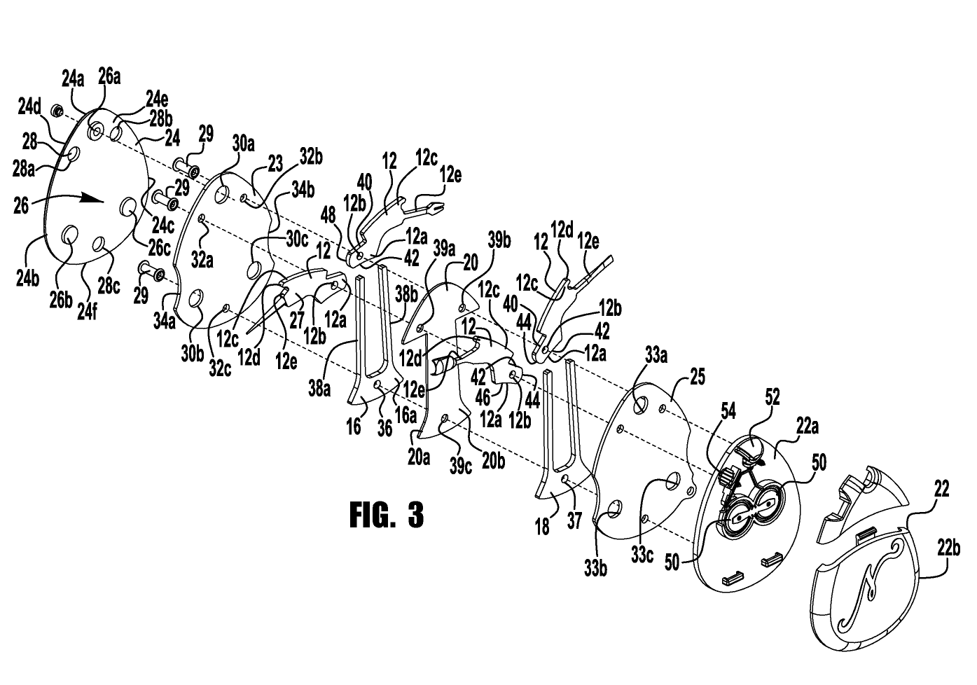

The housing 14 of the smoker's multi-tool 10 is composed of front cover 16 and rear cover 18. The various tools 12, first and second springs 16 and 18, respectively, intermediate support segment 20, and first inner cover 23 and second inner cover 25 are secured between a front cover 22 and a rear cover 24. The tools 12 are snugly mounted within housing 14 whereby the tools may be rotated from a closed non-functional position to an open, functional position and, by means of their snug fit with the first and second springs 16 and 18, as shown in FIG. 3, held firmly in either position. An of the various tools 12 are designed to independently pivot on a radial axis around the various fasteners, such as rivets 29, between the closed non-functional position and the open functional position.

The rear cover 24 has one or more cylindrically shaped, solid protrusions 26 protruding inward towards the adjacent inner cover 23. As illustrated in FIG. 3, there are three cylindrically shaped, solid protrusions 26a, 26b, and 26c (26a-26c), configured in a triangular relationship to each other. Cylindrically shaped, solid protrusion 26a is positioned at a top portion 24a of the rear cover 24, and cylindrically shaped, solid protrusions 26b and 26c are positioned on bottom left and bottom right portions 24b and 24c, respectively. However, there may be any desired amount of protrusions 26 utilized in any appropriate configuration. As explained hereinbelow, the cylindrically shaped, solid protrusions 26a, 26b, and 26c extend through the openings 30a, 30b and 30c, respectively through the first inner cover 23 and openings 33a, 33b and 33c, respectively, through the second i cover 25.

Further disposed through the rear cover 24 are one or more openings 28. As illustrated, there are three openings 28a, 28b, and 28c (28a-28c), configured in an upside down triangular position. Openings 28a and 28b are positioned within the upper left and upper right portions 24d and 24e, respectively, of the rear cover 24, and opening 28c within a bottom center portion 24f of the rear cover. However, there may be any desired amount of openings 28 utilized in any appropriate configuration. As explained hereinbelow, the openings 28a, 28b, 28c have diameters that are designed to accept rivets 29 which extend through openings 30a, 30b and 30c through first inner cover 23, openings 12b through the various tools 12, openings 36 and 37 through the first and second springs 16 and 18, respectively, openings 39a, 39b and 39c through intermediate support segment 20 and openings 33a, 33b and 33c through the second inner cover 25.

Adjacent to the rear cover 24 is a first inner cover 23. First inner cover 23 has a series of openings 30a, 30b, and 30c (30a-30c), which conform to the cylindrically shaped, solid protrusions 26a-26c. The openings 30a-30c have a diameter which securely fits about the cylindrically shaped, solid protrusions 26a-26c. Moreover, first inner cover 23 has a series of openings 32a, 32b, and 32c (32a-32c), which conform to the location of the openings 28a-28c through cover 24. The openings 32a-32c have a diameter that is designed to accept the rivets 29 which extend through the various tools 12, the springs 16 and 18, intermediate support segment 20 and the second inner cover 25.

On the bottom left portion 23a and bottom right portion 23b of the first inner cover 23 are cut-out segments 34a and 34b that are designed to allow access to the lever 12d projecting from the middle portion 12c of the tool attachment 12 to allow for access to move the tool into and out of the tool attachment, as described hereinbelow.

Adjacent to the first inner cover 23 is a tool attachment 12. This tool attachment 12 is a pick 27. It should be noted that the various tool attachments 12 throughout are drawn by way of example, and that any desired tool attachments may be utilized. Each of the tool attachments 12, as seen in FIGS. 3, 4 and 5, has a bottom portion 12a with an opening 12b there through to accept the rivet 29. The bottom portion 12a includes first and second side walls 40 and 42 disposed on either side of the through opening 12b and a bottom wall 44 disposed between the first and second side walls 40 and 42. A notch 45 is formed by the intersection of first side wall 40 and a wall 47 extending substantially perpendicular to the first side wall 40. The middle portion 12c of the tool attachment 12 has a lever 12d at an end opposite the wall 47 by which the user may place a finger to grip the tool attachment 12 and draw the tool attachment from a closed position in the multi-tool 10 to an open position. An upper portion 12e of the tool attachment 12 forms a shaft from which one of the specific tools can extend or be formed thereon.

Adjacent to the first inner cover 23 is the first spring 16, as seen in FIG. 3. The first spring 16 has on opening 36 disposed through a bottom center portion 16a to accommodate a rivet 29 therethrough. The first spring 16 has first and second prongs 38a and 38b extending outward from the bottom center portion 16a. Each of the prongs 38a and 38b is designed to firmly brace the tools 12 in place, as described below in reference to FIGS. 4, 5, and 6.

Referring to FIG. 4, the tool attachment 12 of the multi-tool 10 is illustrated in a closed position with the second side wall 42 disposed against the prong 38b of the spring 16. The spring tension of spring 16 acts biases the prong 38b against the flat, side wall 42 to keep the tool secured within the housing 14 of the multi-tool 10.

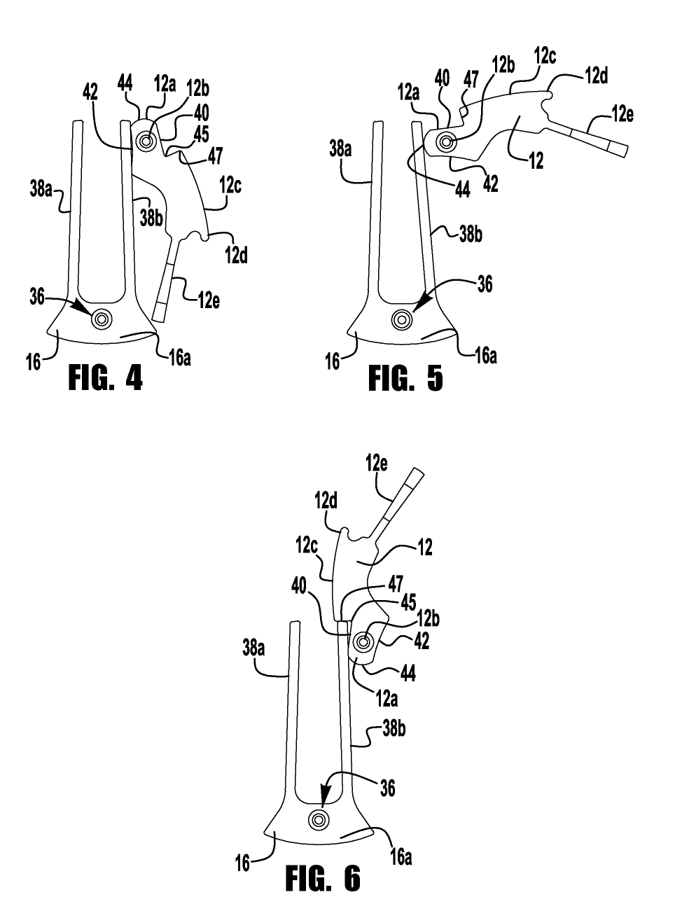

Referring to FIG. 5, there is shown the tool attachment 12 in an intermediate position, midway between the closed position shown in FIG. 3 and an open position shown in FIG. 5. The curved surface of the end 44 of the tool attachment 12 presses against the prong 38b of the spring 16 as the tool rotates about the opening 12b to move the prong 38b towards the prong 38a and exert pressure due to the spring bias of prong 38b against the tool 12.

Referring to FIG. 6, there is shown the tool attachment 12 in a fully open position where the tool is secured outside the housing 14. In this position, the end of the prong 38b is disposed within the notch 45 and against the wall 47 whereby the prong 38b moves back to its normal, unstressed location.

Referring again to FIG. 3, a tool attachment 12 adjacent to the first spring 16 is a mini fork 27. This tool attachment is otherwise identical to the tool attachment 12 described above, in terms of functionality and construction.

The intermediate support segment 20 is disposed between the springs 16 and 18 and the first and second inner covers 23 and 25. The intermediate support segment 20 has three openings 39a, 39b, and 39c therethrough, through which the rivets 29 extend and connect the rear cover 24, the first inner cover 23, a first tool 12, the spring 16, a second tool 12 to one side 20a of the intermediate support segment 20, a third tool 12, the spring 18, a fourth tool 12 and the second inner cover 25 on the opposite side 20b of the intermediate support segment 20.

The second inner cover 25 is finally attached to an inner section cover 22a of cover 22, as shown in FIGS. 1 and 3. The second inner cover 25 accommodates the rivets 29 and the cylindrically shaped, solid protrusions 26a-26c through indentations (not shown) disposed in identical configuration to openings 28a-28c and solid protrusions 26a-26c in the rear cover 24. The inner section cover 22a can be secured to the second inner cover 25 by any desired means such as ultrasonic welding.

As seen in FIGS. 1 and 3, the cover 22 has a removable outer section 22b, and an inner section 22a. Disposed on the outer facing side of the inner section 22a is a battery 50, which powers alight 52. The light 52 is controlled with light switch 54. The outer section 22b is designed to accommodate the light 52 and light switch 54. Further, the outer section 22b is designed to be easily removable from the inner section 22a to allow for easy access to the battery 50.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A smoker's multi-tool that integrates one or more tools for various tasks associated with smoking, comprising;
one or more tools mounted within a housing;
the one or more tools may be rotated from a closed non-functional position within the housing to an open, functional position extending outward from the housing;
a first spring mounted within the housing having first and second prongs wherein the first prong engages one of the one or more tools whereby spring tension of the first prong is exerted against the one of the one or more tools secured within the housing in the closed non-functional position; and
an end of the first prong engages the one of the one or more tools whereby the first prong moves into an unstressed condition when the multi-tool is secured in an open position.

2. The smoker's multi-tool of claim 1, further including the one or more tools, one or more springs, an intermediate support segment, and a first inner cover and a second inner cover being secured between a front cover and a rear cover.

3. The smoker's multi-tool of claim 2, wherein the one or more tools are snugly mounted within the housing whereby the tools may be rotated from a closed non-functional position to an open, functional position and, by means of their snug fit with the one or more springs, held firmly in either position.

4. The smoker's multi-tool of claim 3, further including each of the one or more tools having:
a bottom portion with an opening therethrough to accept the one or more rivets;
each bottom portion includes first and second side walls disposed on either side of the through opening;
a bottom wall disposed between the first and second side walls;
a notch formed by the intersection of first side wall and a wall extending substantially perpendicular to the first side wall;
a middle portion having a lever at an end opposite the wall by which the user may place a finger to grip the tool and draw the tool from a closed position in the multi-tool to an open position; and
an upper portion of the tool forming a shaft from which one of the one or more tools can extend or be formed thereon.

5. The smoker's multi-tool of claim 4, wherein the one or more tools independently pivot on a radial axis around one or more rivets between the closed non-functional position and the open functional position.

6. The smoker's multi-tool of claim 5, wherein a first of the one or more tools is mounted between the first inner cover and a first spring, and a second of the one or more tools is mounted between the first spring and the intermediate support segment.

7. The smoker's multi-tool of claim 1, where:
a second prong engages the second of the one or more tools whereby spring tension of the second prong is exerted against the second of the one or more tools secured within the housing in the closed non-functional position; and
an end of the second prong engages a second of the one more tools whereby the second prong moves into an unstressed condition when the multi-tool is secured in an open position

8. The smoker's multi-tool of claim 7, further including the second of the one or more tools having:
a bottom portion having first and second side walls with an opening therebetween to accept the one or more rivets;
a bottom wall disposed between the first and second side walls;
a notch formed by the intersection of the first side wall and a wall extending substantially perpendicular to the first side wall;
a middle portion having a lever at an end opposite the wall by which the user may place a finger to grip the tool and draw the tool from a closed position in the multi-tool to an open position; and
an upper portion of the second of the one or more tools forming a shaft from which one of the one or more tools can extend or be formed thereon.

9. The smoker's multi-tool of claim 1, further including a curved surface of an end of each of the one or more tools that presses against the first prong of the first spring as the tool rotates to move the first prong towards the second prong and exert pressure due to the spring bias of the first prong against one of the one or more tools, when the multi-tool is in a closed position.

10. The smoker's multi-tool of claim 12, further including cut-out segments on the first inner cover to allow access to a lever projecting from a middle portion of the one or more tools.

11. The smoker's multi-tool of claim 1, further including a battery disposed on an outer facing side of an inner section, which powers a light, which is disposed within an outer section.

12. A smoker's multi-tool that integrates a plurality of tools for various tasks associated with smoking, comprising;
a housing having the plurality of tools mounted therein;
the housing comprising a first inner cover and a second inner cover, an intermediate support segment disposed between the first inner cover and the second inner cover, a first spring between the first inner cover and the intermediate support segment and a second spring between the intermediate support segment and the second inner cover; and
a first of the plurality of tools mounted between the first inner cover and the first spring, a second of the plurality of tools mounted between the first spring and the intermediate support segment, a third of the plurality of tools mounted between the intermediate support segment and the second spring, and a fourth of the plurality of tools mounted between the second spring and the second inner cover whereby the plurality of tools may be rotated from a closed non-functional position within the housing to an open, functional position extending outward from the housing.

13. The smoker's multi-tool of claim 12, wherein the housing has a front cover mounted to an outward facing surface of the first inner cover and a rear cover mounted to an outward facing surface the second inner cover.

14. The smoker's multi-tool of claim 13, wherein the plurality of tools, the first and second springs, the intermediate support segment and the first inner cover and the second inner cover are secured between the front cover and the rear cover.

15. The smoker's multi-tool of claim 14, wherein the plurality of tools are rotated from a closed non-functional position within the housing to an open, functional position extending outward from the housing and by removably engaging the first and second springs, the plurality of tools are held firmly in either the closed non-functional position or the open, functional position.

16. The smoker's multi-tool of claim 15, wherein the plurality of tools each independently pivot about a fastener extending through the first inner cover, the first plurality of tools, the first spring, the intermediate support segment, the third plurality of tools, the second spring, and the fourth of the plurality of tools whereby the plurality of tools may be rotated from the closed non-functional to the open functional position.

17. The smoker's multi-tool of claim 16, wherein:
the first spring has first and second prongs extending outward from the bottom center portion of the first spring and a mounting hole disposed through the bottom center portion of the first spring to receive the fastener; and
the second spring has first and second prongs extending outward from the bottom center portion of the second spring and a mounting hole disposed through the bottom center portion of the second spring to receive the fastener.

18. The smoker's multi-tool of claim 17, wherein each of the plurality of tools has a bottom portion with a mounting hole there through to accept the fastener, the bottom portion includes first and second side walls disposed on either side of the mounting hole and a bottom wall disposed between the first and second side walls, a notch is formed by the intersection of the first side wall and a narrow wall extending substantially perpendicular to the first side wall.

19. The smoker's multi-tool of claim 18, further including a curved surface of an end of each of the one or more tools that presses against the first prong of the first spring as the tool rotates to move the first prong towards the second prong and exert pressure due to the spring bias of the first prong against one of the one or more tools, when the multi-tool is in a closed position.

20. The smoker's multi-tool of claim 19, further including a battery disposed on an outer facing side of an inner section, which powers a light, which is disposed within an outer section.
